(19) United States
(12) Patent Application Publication
(10) Pub. No.: US 2015/0065216 A1
(43) Pub. Date: Mar. 5, 2015

(54) METHODS AND SYSTEMS OF GENERATING AN ELECTRONIC ENTERTAINMENT WAGERING SYSTEM

(71) Applicant: Adam Jae Chun Lee, Honolulu, HI (US)

(72) Inventor: Adam Jae Chun Lee, Honolulu, HI (US)

(21) Appl. No.: 14/474,540

(22) Filed: Sep. 2, 2014

Related U.S. Application Data
(60) Provisional application No. 61/871,872, filed on Aug. 30, 2013.

(51) Int. Cl. A63F 13/792; A63F 13/49

(52) U.S. Cl. CPC A63F 13/792; A63F 13/49
USPC 463/9

(57) ABSTRACT

An electronic entertainment wagering system is provided. The electronic entertainment wagering system includes a video game challenge engine configured to receive first team selection data from a first player. The first team selection data includes a first plurality of video game players selected by the first player to be on a first team. The video game challenge engine is further configured to receive second team selection data from a second player. The second team selection data includes a second plurality of video game players selected by the second player to be on a second team. The video game challenge engine is further configured to receive video game player data. The video game player data includes statistical performance data over a plurality of video game events for the first plurality of video game players and the second plurality of video game players. The video game challenge engine evaluates the video game player data to determine a winner for a challenge between the first team and the second team. The system also includes a game rules and scoring database that includes game rules for evaluating the statistical performance data of the players during the video game events.

### CROSS-REFERENCE TO RELATED APPLICATIONS

This application claims the benefit of U.S. provisional application 61/871,872 which was filed on Aug. 30, 2013 and whose contents are incorporated by reference herein.

### BACKGROUND

Video games are popular. People play video games online, or on gaming consoles, including e.g. Nintendo, PlayStation etc. Some players play professionally, as part of video game leagues, either as an individual or as part of a team. Such game play is sometimes referred to as Electronic Sports (e-sports), competitive gaming, professional gaming and/or cybersport. These professional video game players often play tournaments for real money and are often sponsored by various companies seeking association with their game play. Cash prizes for winning various video game events continues to grow as the attention paid to e-sports rises.

Professional video game players have fans. The attendance and size of the venues for video game oriented events has grown to the thousands of spectators, many of which watch the game play over the internet, just like how NBA or NFL fans watch football on TV or online. These fans have an interest in observing and wagering on the outcome of these events. However, there does not exist a system for providing real money challenges around video game players and video game events.

The foregoing examples of the related art and limitations related therewith are intended to be illustrative and not exclusive. Other limitations of the related art will become apparent upon a reading of the specification and a study of the drawings.

### BRIEF DESCRIPTION OF THE DISCLOSURE

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

In accordance with the teachings herein, a system allows video game e-sport fans (“fans”) to challenge each other for real money based on the performance of professional video game players (“players”). The professional video game players can be selected to form teams including video game players playing in real professional video game events (“events”), e.g., video game league competitions or video game tournaments. The players can be included in the fan's teams regardless of whether the professional players are on real teams together or playing against each other in actual video game matches. Further, such fans can deposit funds, create teams, and compete against other fans in choosing the best video game players and creating the best video game team.

A challenge is a scored comparison of the performance of a minimum of two fans in creating teams of players over various events (“challenge”). A challenge includes at least two video game players and is scored over one or more events. After completion of the events, the performance of teams can be compared by a system that grades the challenges and awards the winner(s) with the prize(s). Cash and other prizes may be awarded to participants and/or winning fans.

### BRIEF DESCRIPTION OF THE DRAWINGS

FIG. 1 depicts an example of a system for performing real money challenges around video game players and video game events.

FIG. 2. depicts an example of a system for performing real money challenges around video game players and video game events.

FIG. 3. depicts an example of a data storage system for performing real money challenges around video game players and video game events.

FIG. 4 depicts a flowchart of an example of a method for preparing, entering and confirming a video game team to enter a challenge around video game players and video game events.

FIG. 5 depicts a flowchart of an example of a method for matching up the least similar teams and users reviewing fan teams.

FIG. 6 depicts a flowchart of an example of a method for monitoring video game events.

FIG. 7 depicts a flowchart of an example of a method for scoring a challenge.

FIG. 8 depicts an example of a system for performing real money challenges around video game players and video game events.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

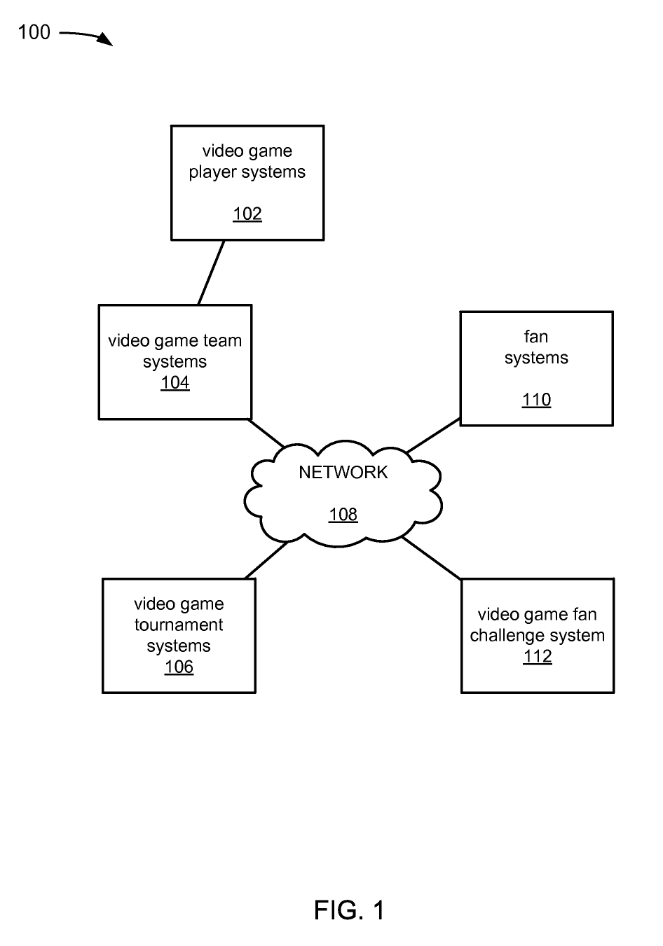

FIG. 1 depicts an example of a system for performing real money challenges around video game players and video game events. FIG. 1 includes video game player systems 102, video game team systems 104, video game tournament systems 106, network 108, fan systems 110, and video game challenge system 112.

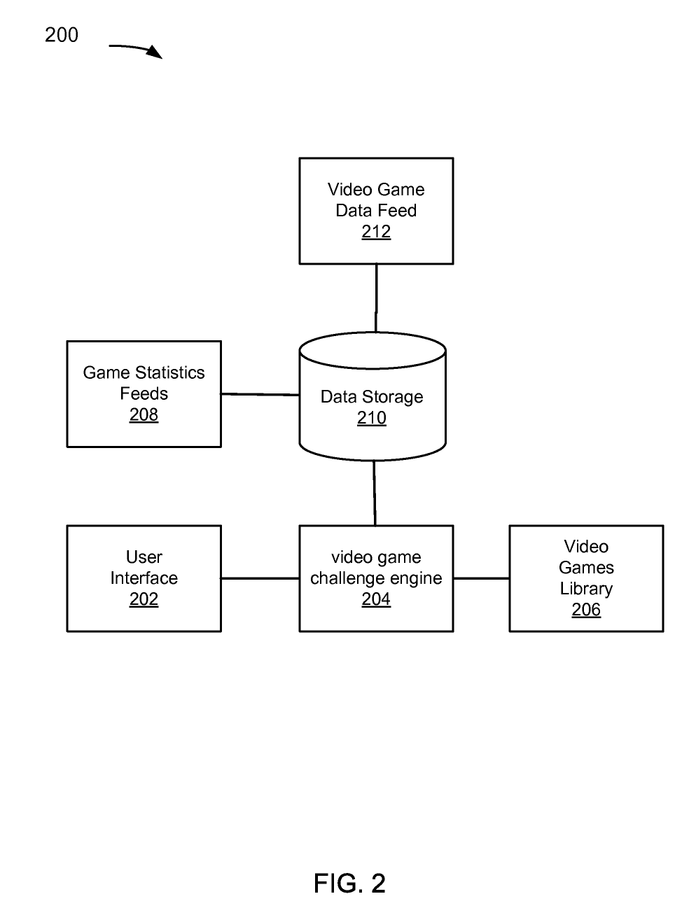

FIG. 2 depicts an example of a system for performing real money challenges around video game players and video game events. The system includes databases, interfaces, libraries and data feeds necessary to provide a platform that fans may use to challenge each other for real money in regard to the performance of players. Data feeds receive incoming player statistics that are generated during video game events. The statistics are reviewed by players via the interfaces who use the information to determine how to form their teams and enter challenges. The system monitors the performance of the players on the teams and scores the challenges. In accordance with the results, the system awards prizes to the winning fans.

In the example of FIG. 2, data storage 210 can be a data repository for storing all information associated with an electronic entertainment wagering system. As used in this paper, a “repository” can be implemented, for example, as software embodied in a physical computer—readable medium on a general-purpose or specific-purpose machine, in firmware, in hardware, in a combination thereof, or in any applicable known or convenient device or system.

The repositories described in this paper are intended, if applicable, to include any organization of data, including tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, FileMaker, Informix, Microsoft Access, Microsoft SQL Server, Microsoft Visual FoxPro, MySQL, and Open Office, org Base, to name several, however, any known or convenient DBMS can be used.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

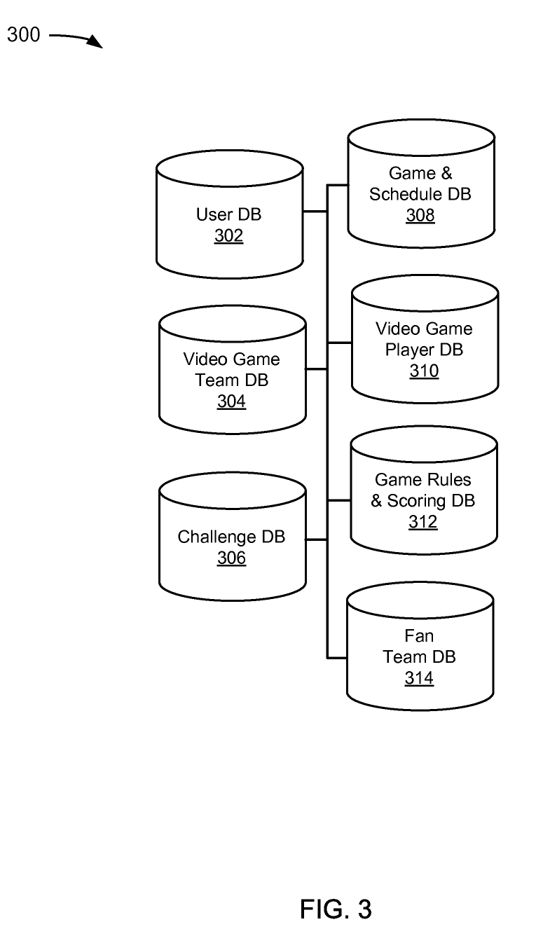

FIG. 3. depicts an example of a data storage system for a system for performing real money challenges around video game players and video game events. FIG. 3 includes User DB 302, Video Game Team DB 304, Challenge DB 306, Game & Schedule DB 308, Video Game Player DB 310, Game Rules & Scoring DB 312, and Fan Team DB 314. As used in this figure, DB means data repository.

In the example of FIG. 3, User DB 302 can be a database that holds all information related to the User such as profile, player history, account information, challenges, and all historical data related to the User.

In the example of FIG. 3, Video Game Team DB 304 can be a database that holds all the information related to a Video Game Team that plays in real video game events such as a list of all the players that are on the Video Game Team, the records of the team, the record of the players that make up the team, the team schedule, the history of all challenges related to the team, team results.

In the example of FIG. 3, Challenge DB 306 can be a database that holds all information related to the Challenge including the entry amounts, prizes, participants, fan's players, fan's teams, events that have fan's players participating.

In the example of FIG. 3, Game and Schedule DB 308 can be a database that holds all the information related to the games and schedules for the video game players and video game teams. Just like in NFL, there can be scheduled games and schedules, with set starting times and set distribution channels for fans to watch the event.

In the example of FIG. 3, Video Game Player DB 310 can be a database of all the video game players that are participating in real life video game events. The database will hold the information of the video game players that users are able to choose from in order to create their video game fantasy team. Information included can be all the player info such as their stats, history in previous events, history in previous tournaments, results against other players or teams, and any other info that is related to the video game results and the player's performance in those events.

In the example of FIG. 3, Game Rules and Scoring DB 312 can be a database that holds all the information related to game rules and the method of scoring that is used to determine the fantasy game scores of each player and each team in the challenge. Game rules can include how to enter a challenge, how to enter money, how to select a player, how to create a team, how to withdraw money, and any other part of the game from start to finish.

In the example of FIG. 3, Fan Team DB 314 can be a database that holds all the information related to the team that the fan has created by selecting various video game player and creating their own Fan Team. The Fan Team DB holds the information for all fan teams over all challenges.

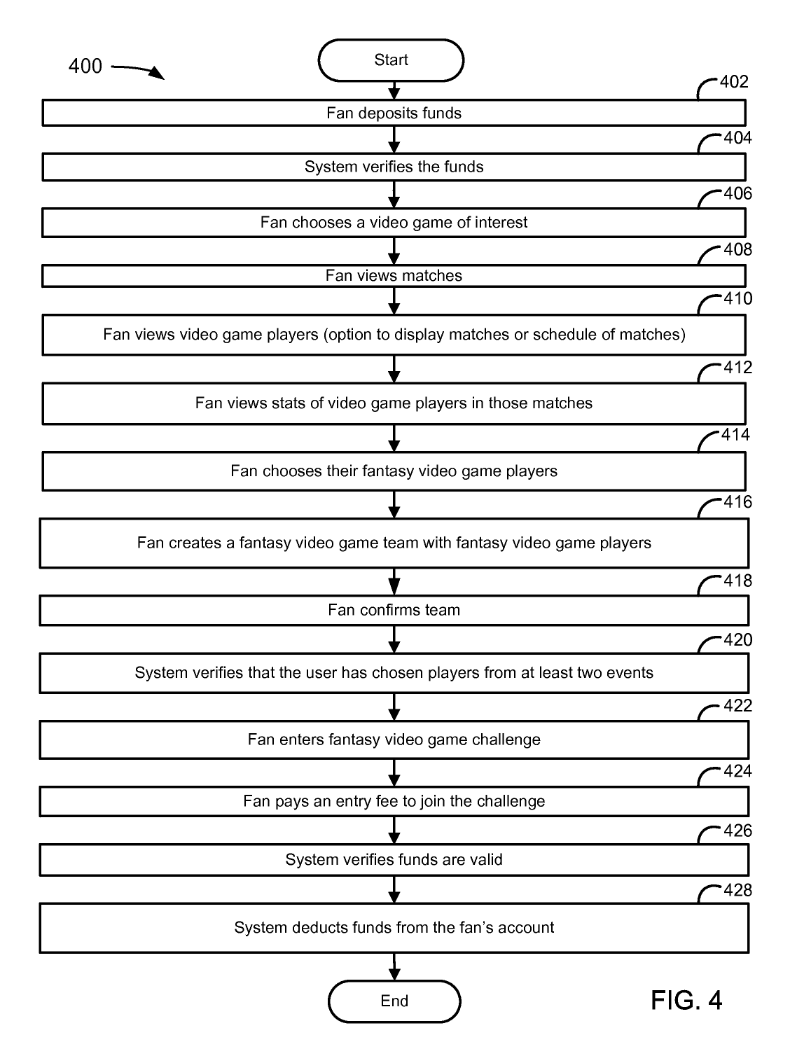

FIG. 4 depicts a flowchart of an example of a method for preparing a challenge around video game players and video game events. The methods included herein are organized into modules in a certain order, however, the modules may be rearranged and reorganized as is known or convenient to implement the method.

In the example of FIG. 4, the flowchart starts at module 400 where the fan deposits funds in order to enter challenges that require an entry fee.

In the example of FIG. 4, the flowchart continues to module 404 where the system verifies that the funds the User deposited to their account are verified and secured by the system. The funds will be used by the User to pay for entry fees into video game challenges.

In the example of FIG. 4, the flowchart continues to module 406 where the user can view a variety of video games and choose one of them to participate in a real money challenge specifically around that video game and video game players that are playing that game. An example would be a fan being able to view John Madden Football, Super Mario Kart or League of Legends. The user decides to participate in a John Madden Football challenge and selects the John Madden Football video game as his choice.

In the example of FIG. 4, the flowchart continues to module 408 where the fan can view all the matches that are related to the video game that the User selected and all info related to those matches such as the starting time, how many video game players are playing, which video game teams are participating, records of the teams that are in the Matches, records of the video game players that are in the Matches and any other info related to the Match.

In the example of FIG. 4, the flowchart continues to module 410 where the user can view the video game players that are involved in the Matches and all info related to the players including their history, record, stats, photo, profile, contact info.

In the example of FIG. 4, the flowchart continues to module 412 where the user can view all stats of the video game players that are participating in the matches. The stats available can include current and historical stats of the video game players.

In the example of FIG. 4, the flowchart continues to module 414 where the user chooses their fantasy video game players. The user decides which video game players to choose for their team based on the rules of the game.

In the example of FIG. 4, the flowchart continues to module 416 where the user creates a fantasy video game team with fantasy video game players. The video game players that the user chooses make up the user's team.

In the example of FIG. 4, the flowchart continues to module 418 where the Fan confirms that the video game players they have selected to make up their team are correct. The user confirms the user's team and the fan's team is saved.

In the example of FIG. 4, the flowchart continues to System verifies that the user has chosen players from at least two events 420. In order to proceed successfully the user has selected video game players from at least two video game events.

In the example of FIG. 4, the flowchart continues to module 422 where the fan enters a fantasy video game challenge. The user enters their fantasy team into a video game challenge to compete against another a 2^{nd} user that has also created a fantasy team consisting of video game players that the 2^{nd} user has chosen.

In the example of FIG. 4, the flowchart continues to module 424 where the fan pays an entry fee to join the challenge. The fan pays the amount of the entry fee from the funds that were deposited and confirmed to the fan's account.

In the example of FIG. 4, the flowchart continues to module 426 where the system verifies funds are valid. The system makes sure that the entry fee amount paid by user is valid and secures the funds in an account separate from the Fan's account, so that the Fan has no control over the entry fee once they pay it.

In the example of FIG. 4, the flowchart continues to module 428 where the system deducts funds from the fan's account. The amount paid for the entry fee by fan is deducted from the fan's account. Having successfully paid a confirmed entry fee to join a challenge the flowchart ends.

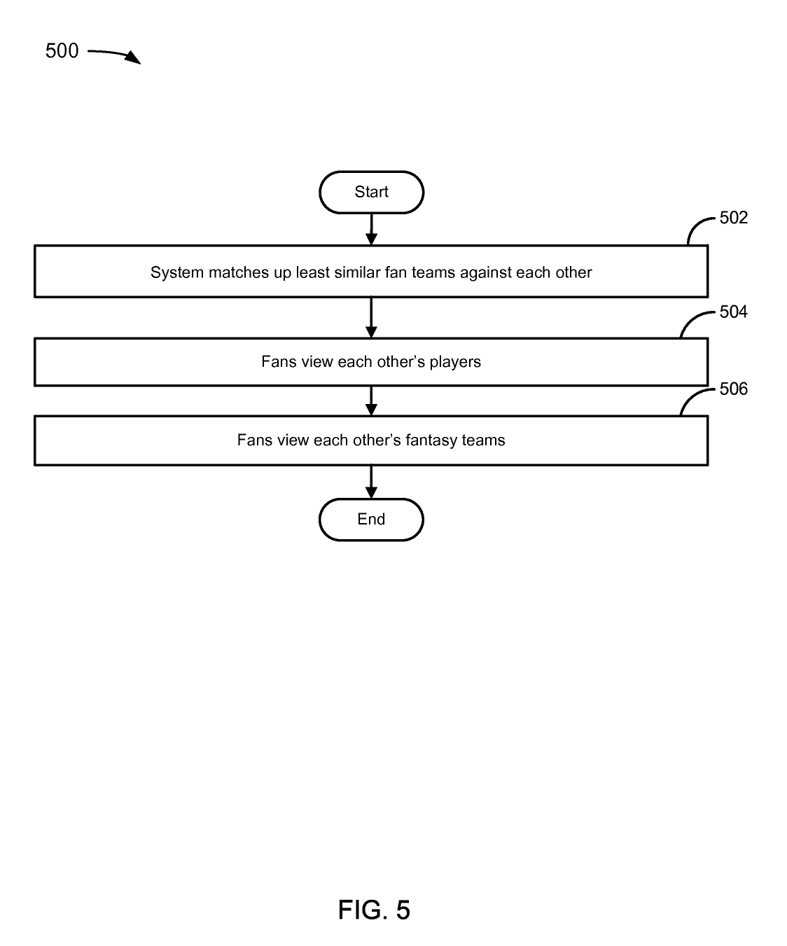

FIG. 5 depicts a flowchart of an example of a method for matching up Fan's teams and allowing Fans to review their team and the team(s) of opponent(s). In accordance with this method, the system matches up fans who have the least similar teams with each other and allow both fans to view each other's fan teams, who may then review their teams in order to challenge each other for real money with regard to the statistics of the players on their teams.

In the example of FIG. 5 the flowchart starts at 502 where the system matches up fan teams against each other. Here, the system will match up the least similar teams with each other to create the most diversity between opponents with different fan teams.

In the example of FIG. 5 the flowchart continues to 504 where the fans can see the players that the other Fan (their opponent) has chosen.

In the example of FIG. 5 the flowchart continues to 506 where the fans can see the entire fan team that their opponent has chosen. Having successfully matched up opponent's against each other and making fan teams available to both fans in the challenge, the flowchart ends.

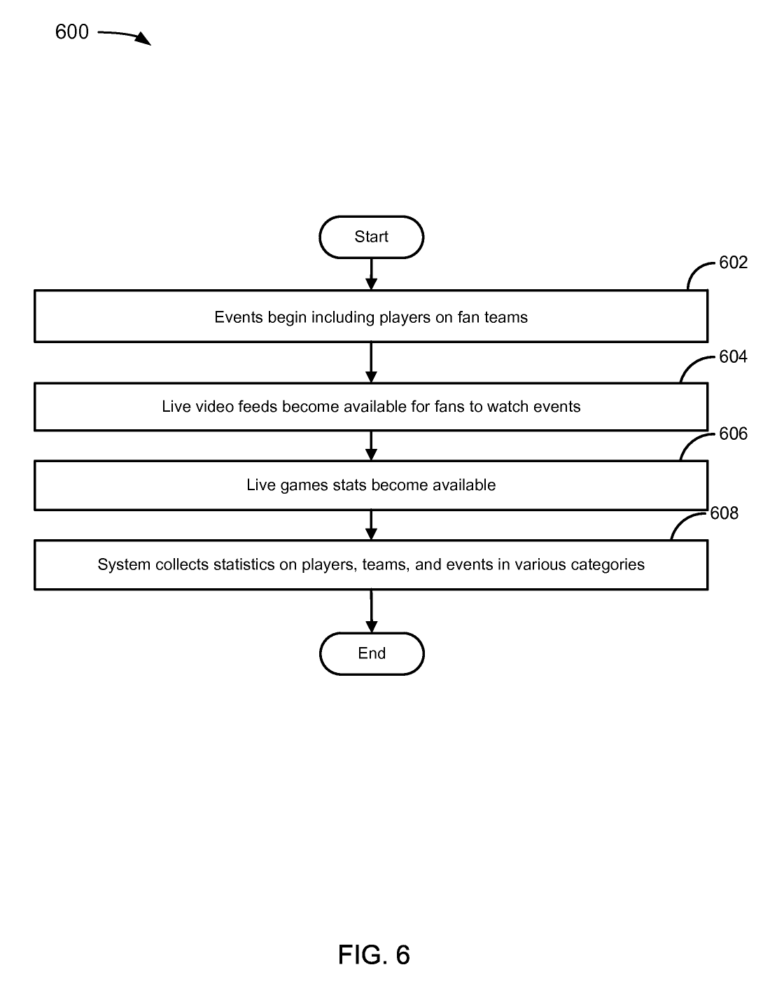

FIG. 6 depicts a flowchart of an example of a method for monitoring video game events. In accordance with the method, events begin and generate player data used to evaluate the players and ultimately the teams. Fans may watch the events and observe the statistics of the players.

In the example of FIG. 6 the flowchart starts at module 602 where the the events that the video game players are participating in start.

In the example of FIG. 6 the flowchart continues to module 604 where live video feeds become available for fans to watch events. Live video feeds of the matches become available for viewing via the internet or some other medium to watch the matches so that fans can watch the event which affects the outcome of their players, team, entry fee and prize.

In the example of FIG. 6 the flowchart continues to module 606 where live game stats become available. The stats for the event including the score, player scores, player stats, time remaining become available via a data feed to keep all interested parties updated in real time on the progress of the events that related to the challenge.

In the example of FIG. 6 the flowchart continues to module 608 where the system collects statistics on players, teams, and events in various categories. As the event goes on the system is tracking and collecting a variety of stats including all the stats categories that directly or indirectly affect the scoring of the challenge according to the scoring rules of the league.

With the system allowing Fans the ability to view the event along with the related statistics in the events the flowchart in FIG. 6 ends.

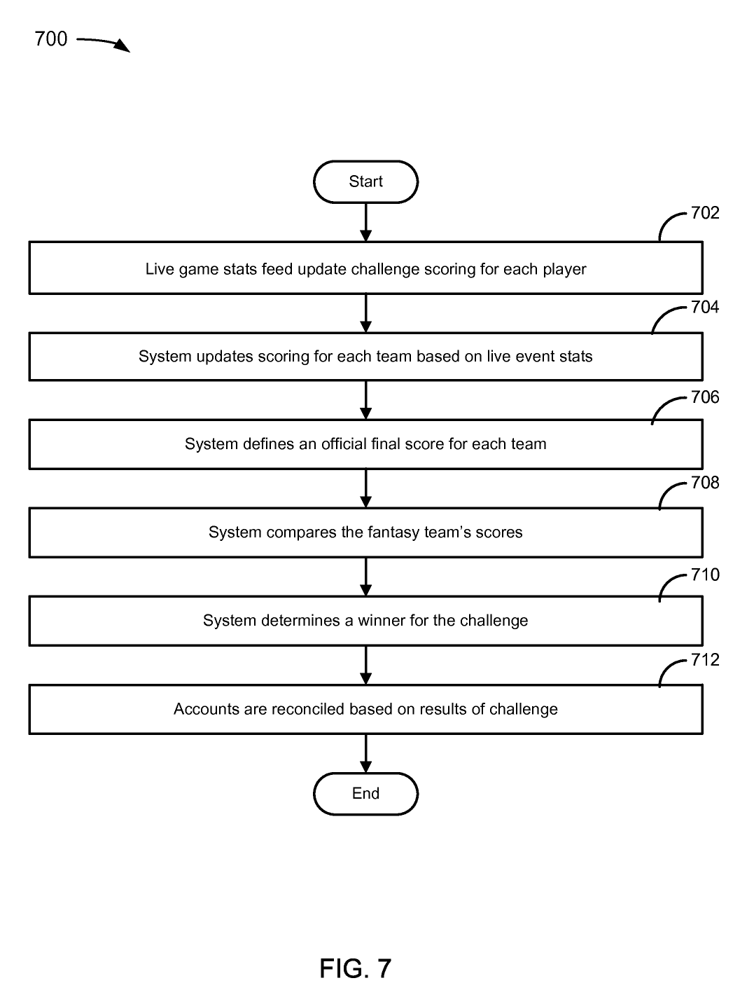

FIG. 7 depicts a flowchart of an example of a method for scoring a challenge. In accordance with the method, team scores are updated to provide statistics for each player throughout the event until the event is complete and the scores are complete. At completion, a final score is provided and a winner is selected. Fan accounts are then updated to reflect the change in funds.

In the example of FIG. 7, the flowchart starts at module 702 where a live game stats data feed updates the challenge scoring for each player 702. The data feed updates the scoring for each player in the challenge based on the statistical results of the player .

In the example of FIG. 7, the flowchart continues to module 704 where the system updates scoring for each team based on live event stats. Based on the individual player scores, the team score updates accordingly.

In the example of FIG. 7, the flowchart continues to module 706 where the system defines an official final score for each team. Based on the statistical results of all the fantasy players on the fan's team, a final score for each team is determined.

In the example of FIG. 7, the flowchart continues to module 708 where the system compares the fantasy team scores. The system compares the official fan team scores for each entry so a winner can be determined.

In the example of FIG. 7, the flowchart continues to module 710 where the system determines a winner for the challenge. The fantasy team with the most points is determined to be the winner and receives the prize.

In the example of FIG. 7, the flowchart continues to module 712 where the system reconciles accounts are based on results of challenge 712. The accounts for each fan are adjusted according to the result of the challenge.

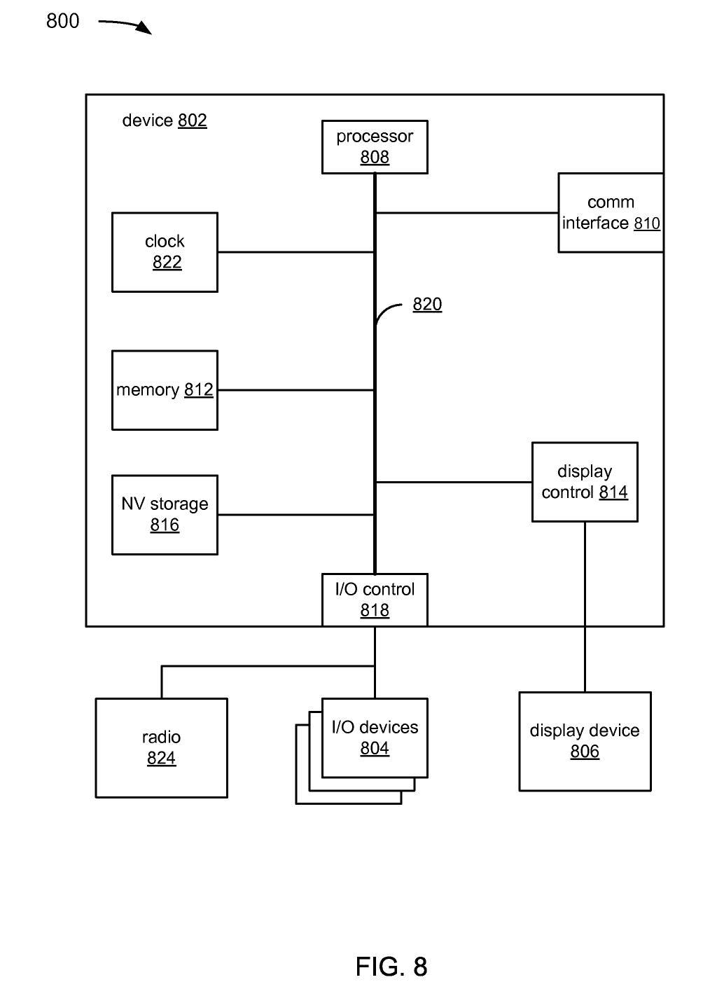

FIG. 8 depicts an example of a system for performing real money challenges around video game players and video game events. The system 800 may be a conventional computer system that can be used as a client computer system, such as a wireless client or a workstation, or a server computer system. The system 800 includes a device 802, I/O devices 804, and a display device 806. The device 802 includes a processor 808, a communications interface 810, memory 812, display controller 814, non-volatile storage 816, I/O controller 818, clock 822, and radio 824. The device 802 may be coupled to or include the I/O devices 804 and the display device 806.

The device 802 interfaces to external systems through the communications interface 810, which may include a modem or network interface. It will be appreciated that the communications interface 810 can be considered to be part of the system 800 or a part of the device 802. The communications interface 810 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE / EGPRS), High-Speed Downlink Packet Access (HSPDA) interface, or other interfaces for coupling a computer system to other computer systems.

The processor 808 may be, for example, a conventional microprocessor such as an Intel Pentium microprocessor or Motorola power PC microprocessor. The memory 812 is coupled to the processor 808 by a bus 820. The memory 812 can be Dynamic Random Access Memory (DRAM) and can also include Static RAM (SRAM). The bus 820 couples the processor 808 to the memory 812, also to the non-volatile storage 816, to the display controller 814, and to the I/O controller 818.

The I/O devices 804 can include a keyboard, disk drives, printers, a scanner, and other input and output devices, including a mouse or other pointing device. The display controller 814 may control in the conventional manner a display on the display device 806, which can be, for example, a cathode ray tube (CRT) or liquid crystal display (LCD). The display controller 814 and the I/O controller 818 can be implemented with conventional well known technology.

The non-volatile storage 816 is often a magnetic hard disk, flash memory, an optical disk, or another form of storage for large amounts of data. Some of this data is often written, by a direct memory access process, into memory 812 during execution of software in the device 802. One of skill in the art will immediately recognize that the terms “machine-readable medium” or “computer-readable medium” includes any type of storage device that is accessible by the processor 808.

Clock 822 can be any kind of oscillating circuit creating an electrical signal with a precise frequency. In a non-limiting example, clock 822 could be a crystal oscillator using the mechanical resonance of vibrating crystal to generate the electrical signal.

The radio 824 can include any combination of electronic components, for example, transistors, resistors and capacitors. The radio is operable to transmit and/or receive signals.

The system 800 is one example of many possible computer systems which have different architectures. For example, personal computers based on an Intel microprocessor often have multiple buses, one of which can be an I/O bus for the peripherals and one that directly connects the processor 808 and the memory 812 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 812 for execution by the processor 808. A typical computer system will usually include at least a processor, memory, and a bus coupling the memory to the processor.

In addition, the system 800 is controlled by operating system software which includes a file management system, such as a disk operating system, which is part of the operating system software. One example of operating system software with its associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage 816 and causes the processor 808 to execute the various acts required by the operating system to input and output data and to store data in memory, including storing files on the non-volatile storage 816.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. An electronic entertainment wagering system comprising:
a video game challenge engine configured to:
receive first team selection data from a first player, wherein the first team selection data includes a first plurality of video game players selected by the first player to be on a first team;
receive second team selection data from a second player, wherein the second team selection data includes a second plurality of video game players selected by the second player to be on a second team;
receive video game player data, wherein the video game player data includes statistical performance data over a plurality of video game events for the first plurality of video game players and the second plurality of video game players;
evaluate the video game player data to determine a winner for a challenge between the first team and the second team; and
a game rules and scoring database that includes game rules for evaluating the statistical performance data of the players during the video game events.

2. The electronic entertainment wagering system of claim 1, wherein the video game events are at least one of electronic sporting game events, multiplayer online battle arena (“MOBA”) events, and video game racing events.

3. The electronic entertainment wagering system of claim 1, wherein the video game challenge engine is further configured to provide a data feed to at least one of the first player and the second player, where the data feed includes at least one of a game score, a particular video game player score, a particular video game player stats, and time remaining in the video game event.

4. The electronic entertainment wagering system of claim 3, wherein the data feed is provided in substantially real-time to the at least one of the first player and the second player during at least one of the video game events.

5. The electronic entertainment wagering system of claim 1, wherein the video game challenge engine is further configured to receive a real money challenge from the first player and the second player.

6. The electronic entertainment wagering system of claim 5, wherein the video game challenge engine is further configured to reconcile a first player account and a second player account based on the winner of the challenge.

7. The electronic entertainment wagering system of claim 1, wherein the first player and the second player pay an entry fee to enter the challenge.

8. The electronic entertainment wagering system of claim 1, wherein the first player and the second player do not pay an entry fee and compete for at least one of cash and prizes.
